(19) United States
(12) Patent Application Publication
(10) Pub. No.: US 2012/0072973 A1
(43) Pub. Date: Mar. 22, 2012

(54) METHOD AND APPARATUS FOR AUTHENTICATION IN PASSIVE OPTICAL NETWORK AND PASSIVE OPTICAL NETWORK

(75) Inventors: Bo Gao, Shenzhen (CN); Wei Lin, Shenzhen (CN)

(73) Assignee: Huawei Technologies Co., Ltd, Shenzhen (CN)

(21) Appl. No.: 13/305,421

(22) Filed: Nov. 28, 2011

Related U.S. Application Data
(63) Continuation of application No. PCT/CN2010/071904, filed on Apr. 20, 2010.

(30) Foreign Application Priority Data
May 28, 2009 (CN) 200910107749.5

(51) Int. Cl. G06F 21/20

(52) U.S. Cl. 726/5

(57) ABSTRACT

The embodiments of the present disclosure provide a method and an apparatus for authentication in a Passive Optical Network (PON), and a PON. The method includes: receiving, by an Optical Network Unit/Optical Network Terminal (ONU/ONT), a first negotiation message sent by an Optical Line Terminal (OLT), and authenticating the OLT according to a logic registration ID of the OLT; sending, by the ONU/ONT, a second negotiation message to the OLT, the logic registration ID of the ONU/ONT is used to enable the OLT to authenticate the ONU/ONT according to a logic registration ID of the ONU/ONT, and allocates a terminal identifier for the ONU/ONT after the authentication succeeds. In the embodiments of the present disclosure, the OLT and the ONU/ONT are authenticated through the logic registration IDs, thus eliminating security threats in the authentication process.

### CROSS-REFERENCE TO RELATED APPLICATIONS

This application is a continuation of International Application No. PCT/CN2010/071904, filed on Apr. 20, 2010, which claims priority to Chinese Patent Application No. 200910107749.5, filed on May 28, 2009, both of which are hereby incorporated by reference in their entireties.

### FIELD OF THE DISCLOSURE

The present disclosure relates to network communication technologies, and in particular, to a method and an apparatus for authentication in a Passive Optical Network (PON), and a PON.

### BACKGROUND

PON technology is a point-to-multipoint fiber access technology. A PON is generally composed of an Optical Line Terminal (OLT) in the central office, Optical Network Units (ONUs)/Optical Network Terminals (ONTs) at the user side, and an Optical Distribution Network (ODN). One PON port of the OLT may be accessed by multiple ONU/ONTs.

Currently, the authentication in the PON mainly includes authenticating the ONU/ONT by a terminal management device located in a core network through a terminal management protocol TR069, or authenticating the legality of the ONU/ONT on the OLT according to the password reported by the ONU/ONT.

Such case of only the legality of the ONU/ONT being authenticated in the process of authenticating the ONU/ONT is not secure, because the user data is vulnerable to leakage.

### SUMMARY

The technical problems to be solved by the embodiments of the present disclosure are to provide a method, a system and a terminal for authentication in a PON. By using logic registration IDs in the authentication process, the OLT authenticates the terminal automatically, and the ONU/ONT authenticates the OLT, which prevents illegal OLTs from obtaining user information and avoids leakage of user data.

To solve the technical problems mentioned above, the embodiments of the present disclosure are based on the following technical solutions:

A method for authenticating an ONU/ONT in a PON includes the following steps:

receiving, by the ONU/ONT, a first negotiation message sent by an OLT, where the first negotiation message carries a logic registration ID of the OLT, and authenticating the OLT according to the logic registration ID of the OLT;

sending, by the ONU/ONT, a second negotiation message to the OLT, where the second negotiation message carries a logic registration ID of the ONU/ONT, so that the OLT authenticates the ONU/ONT according to the logic registration ID of the ONU/ONT; and

receiving, by the ONU/ONT, a terminal identifier which is sent by the OLT and allocated for the ONU/ONT after both the authentication on the ONU/ONT and the authentication on the OLT succeed.

A PON includes an OLT and an ONU/ONT;

The ONU/ONT is configured to receive a first negotiation message which is sent by the OLT and carries a logic registration ID of the OLT, and authenticate the OLT according to the logic registration ID of the OLT.

The OLT is configured to receive a second negotiation message which is sent by the ONU/ONT and carries a logic registration ID of the ONU/ONT, and authenticate the ONU/ONT according to the logic registration ID of the ONU/ONT.

The OLT sends a terminal identifier which is allocated for the ONU/ONT to the ONU/ONT after both the authentication on the ONU/ONT and the authentication on the OLT succeed.

An ONU/ONT located on a user side of a PON includes:

a storage module, configured to store logic registration IDs of OLTs authorized for access and a logic registration ID of the ONU/ONT;

a logic registration ID receiving module, configured to receive a first negotiation message which is sent by an OLT and carries the logic registration ID of the OLT;

a matching module, configured to match the logic registration ID of the OLT received by the receiving module with the logic registration IDs of the OLTs authorized for access in the storage module;

a logic registration ID sending module, configured to send a second negotiation message which carries a logic registration ID of the ONU/ONT to the OLT, so that the OLT authenticates the ONU/ONT according to the logic registration ID of the ONU/ONT; and

a terminal identifier receiving module, configured to receive a terminal identifier which is sent by the OLT and allocated for the ONU/ONT, where the terminal identifier is sent after both the authentication on the ONU/ONT and the authentication on the OLT succeed.

An OLT located in the central office of a PON includes:

a storage module, configured to store a logic registration ID of the OLT;

a logic registration ID sending module, configured to send a first negotiation message which carries the logic registration ID of the OLT to the ONU/ONT, so that the ONU/ONT authenticates the OLT according to the logic registration ID of the OLT;

a logic registration ID receiving module, configured to receive a second negotiation message which carries a logic registration ID of the ONU/ONT and is returned by the ONU/ONT after the ONU/ONT succeeds in authenticating the OLT according to the logic registration ID of the OLT;

an authenticating module, configured to authenticate the ONU/ONT according to the logic registration ID of the ONU/ONT which is carried in the second negotiation message, and notify a terminal identifier allocating module to allocate a terminal identifier for the ONU/ONT after determining that the authentication on the OLT succeeds; and

the terminal identifier allocating module, configured to allocate the terminal identifier for the ONU/ONT as notified by the authenticating module, and send the allocated terminal identifier to the ONU/ONT.

In the technical solutions of the present disclosure, the ONU/ONT receives the first negotiation message which carries the logic registration ID of the OLT and is sent by the OLT, and authenticates the OLT according to the logic registration ID of the OLT; further, the ONU/ONT sends its own logic registration ID to the OLT so that the OLT authenticates the ONU/ONT. After both the authentication on the ONU/ONT and the authentication on the OLT succeed, the ONU/ONT obtains a terminal identifier allocated for the ONU/ONT from the OLT. In this way, illegal OLTs (malicious OLTs) are prevented from obtaining user information, the leakage of user data is prevented, and the case in which a wrong OLT is accessed is prevented when multiple OLTs are included in the network where the ONU/ONT locates.

### BRIEF DESCRIPTION OF THE DRAWINGS

FIG. 1 is a flowchart of a first method embodiment according to embodiments of the present disclosure;

FIG. 2 is a flowchart of a second method embodiment according to embodiments of the present disclosure;

FIG. 3 is a schematic structural diagram of a system embodiment according to embodiments of the present disclosure;

FIG. 4 is a schematic structural diagram of a first apparatus embodiment according to embodiments of the present disclosure; and

FIG. 5 is a schematic structural diagram of a second apparatus embodiment according to embodiments of the present disclosure.

### DETAILED DESCRIPTION

The technical solutions in the embodiments of the present disclosure are described clearly and thoroughly below in conjunction with the accompanying drawings in the embodiments of the present disclosure. Evidently, the described embodiments are merely some of the embodiments of the present disclosure rather than all embodiments. All other embodiments, which can be derived by persons of ordinary skill in the art based on the embodiments in the present disclosure without any creative effort, shall fall within the protection scope of the present disclosure.

In the embodiments of the present disclosure, the ONU/ONT is discovered and authenticated automatically according to the logic registration ID of the ONU/ONT, and the OLT is discovered and authenticated according to the logic registration ID of the OLT, thus eliminating security threats in the authentication process in the prior art. The following expounds the method according to an embodiment of the present disclosure.

In the embodiments of the present disclosure, the ONU/ONT and the OLT each have their respective logic registration IDs. The OLT stores its own logic registration ID and the logic registration IDs of all legal ONU/ONTs; the ONU/ONT stores its own logic registration ID and the logic registration IDs of all legal OLTs. The logic registration IDs of the ONU/ONTs and the OLT (including the logic registration IDs of the devices themselves and the legal devices) may be allocated by an operation administration system, or generated by the OLT dynamically. The operation administration system transmits the logic registration IDs allocated for the ONU/ONTs and the OLTs to the OLT, and the OLT stores the logic registration IDs it receives. Meanwhile, the operation administration system transmits the logic registration ID of the ONU/ONT to a user. The logic registration IDs of the ONU/ONTs and the logic registration IDs of the OLTs should be unique in a certain area. That is, under a PON port, the logic registration ID of an ONU/ONT should be unique, and the logic registration ID of an OLT should be unique too. Moreover, the specific format of the logic registration ID may be decided by the operation administration system. The logic registration ID may be a password, or a logical identifier allocated by the operator as required, or information related to a device such as the OLT or the ONU/ONT, for example, a device type, a device version, a Media Access Control (MAC) address of the device, a port identifier of the device (such as PON port identifier of the OLT), and/or functions of the device, etc.

If a PON port identifier of the OLT serves as a logic registration ID of the OLT or a part of its logic registration ID, when a jumper wire error occurs in the installation, the ONU/ONT can discover the fault in time when authenticating the OLT, and notify the attendant in a specific mode (such as alarm or indicator). In this way, the fault can be located in the process of authentication. If the device type or device version of the OLT serves as a logic registration ID of the OLT or a part of its logic registration ID, the ONU/ONT can discover mismatch of the version or device type with that of the OLT in time when authenticating the OLT, and notify the attendant in a specific mode (such as alarm or indicator) to upgrade the version or replaces the ONU/ONT. In this way, potential problems are avoided at the time of authentication, and user satisfaction is improved. If the functions of the OLT serve as a logic registration ID of the OLT or a part of its logic registration ID, the ONU/ONT compares the functions supported by ONU/ONT with the logic registration ID of the OLT when authenticating the OLT, and decides whether to continue the registration according to the comparison result; or notifies important supported functions of the ONU/ONT to the attendant in a specific mode (such as alarm or indicator), which facilitates the attendant to decide to upgrade the version or to replace the device during the authentication.

The embodiments of the present disclosure do not restrict the specific style of the logic registration ID of the ONU/ONT and the OLT, and do not restrict which device generates the logic registration ID of the ONU/ONT and the OLT.

An embodiment of the present disclosure provides a method for authenticating a PON, the method includes:

An ONU/ONT receives a first negotiation message sent by an OLT, where the first negotiation message carries a logic registration ID of the OLT, and authenticates the OLT according to the logic registration ID of the OLT;

The ONU/ONT sends a second negotiation message to the OLT, where the second negotiation message carries a logic registration ID of the ONU/ONT, so that the OLT authenticates the ONU/ONT according to the logic registration ID of the ONU/ONT; and

The ONU/ONT receives a terminal identifier which is sent by the OLT and allocated for the ONU/ONT after both the authentication on the ONU/ONT and the authentication on the OLT succeed.

Further, the OLT authenticates the ONU/ONT according to the logic registration ID of the ONU/ONT and the information stored on the OLT; or

The OLT authenticates the ONU/ONT according to the logic registration ID of the ONU/ONT and remote server interaction information. When the OLT authenticates the ONU/ONT according to the remote server interaction message, the type of the 0069nteraction message may be the logic registration IDs or any other information so long as the information can be used for authenticating the ONU/ONT and ensure security of the authentication.

The following describes two exemplary embodiment of the method applied in specific scenarios.

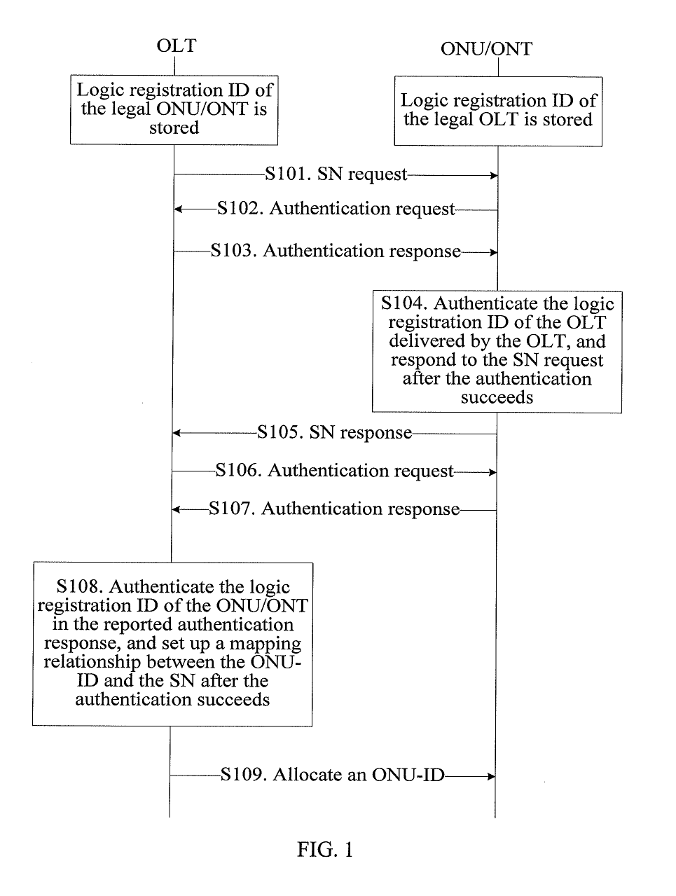

Embodiment 1: as shown in FIG. 1, the method includes the following steps:

S101: The OLT sends a request message to an unregistered ONU/ONT to request the ONU/ONT to report its Sequence Number (SN).

S102: The ONU/ONT sends an authentication request to the OLT after receiving the request message from the OLT.

After receiving the request message from the OLT, the ONU/ONT needs to determine whether the OLT that sends the request message is legal (namely, authorized for access). In this case, an authentication request needs to be sent to the OLT, where the authentication request is used to request a logic registration ID from the OLT. The authentication request in the embodiment of the present disclosure may be an existing Physical Layer Operation Administration Maintenance (PLOAM) message, or a new message defined specially for transmitting the authentication request, provided that the authentication request message includes at least a message type (Message ID) field, which indicates that the authentication request is to request the logic registration ID of the OLT from the OLT.

Preferably, the authentication request in the embodiment of the present disclosure may be a PLOAM message. The structure of the PLOAM message may be as shown in Table 1:

TABLE 1
Authentication Request PLOAM message
Authentication Request PLOAM message

| Byte | Content | Description |
|---|---|---|
| 1 | ONU/ONT ID | Identifier of ONU/ONT/ONT |
| 2 | Message ID | Message ID |
| 3-12 | Reserved | |

In Table 1, the first byte “ONU/ONT ID” is an identifier of the ONU/ONT/ONT that sends the authentication request; the second byte “Message ID” serves to indicate that the message is an authentication request message; and bytes 3-12 are reserved bytes.

S103. After receiving the authentication request sent by the ONU/ONT, the OLT sends an authentication response which carries the logic registration ID of the OLT to the ONU/ONT.

After receiving the authentication request from the ONU/ONT, the OLT may use an existing PLOAM message to transmit the logic registration ID of the OLT to the ONU/ONT, or use a new message specially defined for transmitting its logic registration ID to the ONU/ONT. Moreover, in the process of transmitting the logic registration ID, the logic registration ID may or may not be transmitted in an encrypted mode (the encryption method is also applicable to the subsequent embodiments). The embodiment of the present disclosure does not restrict the specific style of the existing message, and does not restrict the structure of the newly defined message, provided that the authentication response message includes at least a message type field (Message ID) and a logic registration ID field (Register ID).

Preferably, in the embodiment of the present disclosure, a PLOAM message is configured to transmit the logic registration ID of the OLT, and the specific structure of the PLOAM message may be as shown in Table 2:

TABLE 2
PLOAM message for transmitting logic registration ID of OLT
PLOAM message for transmitting logic registration ID of OLT

| Byte | Content | Description |
|---|---|---|
| 1 | ONU/ONT-ID | Identifier of ONU/ONT |
| 2 | Message ID | Message ID |
| 3 | Register ID | Logic registration ID (byte 1) |
| 4-11 | . . . | . . . |
| 12 | Register ID | Logic registration ID (byte 10) |

In Table 2, the first byte “ONU/ONT-ID” is an identifier of the ONU/ONT that receives the authentication response; the second byte “Message ID” serves to indicate that the message is a message for transmitting the logic registration ID; and bytes 3-12 serve to carry the logic registration ID of the OLT.

S104. After receiving the authentication response from the OLT, the ONU/ONT extracts the logic registration ID of the OLT from the authentication response, and matches it with the logic registration IDs of the legal OLTs stored in the ONU/ONT. If the logic registration IDs match, the authentication succeeds, and the procedure proceeds to S105; if the logic registration IDs do not match, the authentication fails, the ONU/ONT aborts subsequent registration and authentication process by, for example, making no response to the authentication request sent by the OLT, or by reporting no SN for an SN request received from the OLT. The authentication is ended.

S105. The ONU/ONT responds to the SN request sent by the OLT, and reports the SN of the ONU/ONT. The format of the message responding to the SN request is the same as that described in steps S102 and S103, but the content of the message carries at least the SN information of the ONU/ONT.

S106. After receiving the SN of the ONU/ONT, the OLT sends an authentication request to the ONU/ONT. The authentication request is intended to authenticate the legality of the ONU/ONT.

After passing the authentication of the OLT by the ONU/ONT, the OLT needs to authenticate the legality of the ONU/ONT. By sending an authentication request to the ONU/ONT, the OLT requests the logic registration ID of the ONU/ONT from the ONU/ONT. The format of the authentication request message is the same as that described in step S102, but the content of the message is to request the logic registration ID of the ONU/ONT from the ONU/ONT.

S107. The ONU/ONT returns an authentication response that carries the logic registration ID of the ONU/ONT.

S108. After receiving the authentication response from the ONU/ONT, the OLT extracts the logic registration ID of the ONU/ONT, and matches it with the logic registration IDs of the legal ONU/ONTs stored in the OLT. The authentication succeeds if the logic registration ID reported by the ONU/ONT matches the logic registration IDs of the legal ONU/ONTs stored in the OLT, and the OLT records the SN of the legal ONU/ONT, allocates an ONU/ONT-ID for the legal ONU/ONT, and binds the SN of the ONU/ONT to the ONU/ONT-ID of the ONU/ONT. The authentication fails if the logic registration ID reported by the ONU/ONT does not match the logic registration IDs of the legal ONU/ONTs stored in the OLT, and the OLT determines the ONU/ONT as illegal, and aborts the registration of the ONU/ONT.

S109. The OLT delivers the allocated ONU/ONT-ID to the ONU/ONT. By exchanging data with the ONU/ONT which is allocated the ONU/ONT-ID, the OLT registers the ONU/ONT. After the registration succeeds, the OLT configures service parameters for the successfully registered ONU/ONT by exchanging data with the successfully registered ONU/ONT.

Preferably, after the ONU/ONT is registered successfully through the above authentication process, in order to further enhance the security in normal use and prevent intrusion of malicious OLT in normal communication process, the ONU/ONT sends an authentication request to initiate the authentication of the OLT after receiving a request information sent by the OLT, such as an encryption key, an authentication password, or an authorization key. Alternatively, the ONU/ONT sends an authentication request autonomously at regular intervals to initiate the authentication of the OLT, and the OLT returns an authentication response which carries the logic registration ID of the OLT to the ONU/ONT after receiving the authentication request.

After receiving the authentication response from the OLT, the ONU/ONT extracts the logic registration ID from the authentication response, and matches this logic registration ID with the legal logic registration ID stored locally. If the logic registration IDs match, the authentication succeeds, and the ONU/ONT responds to the request or grant sent by the OLT; if the logic registration IDs do not match, the authentication fails, and the ONU/ONT does not respond to the information request or grant sent by the OLT.

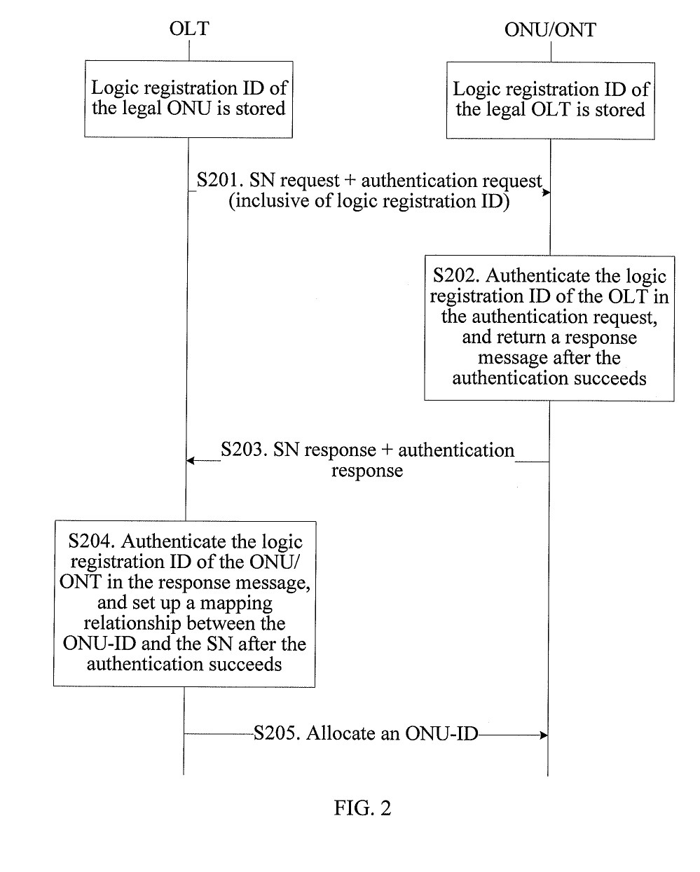

Embodiment 2: as shown in FIG. 2, the method includes the following steps:

S201. The OLT sends a request message to an ONU/ONT. The request message includes an SN request and an authentication request, and the authentication request carries the logic registration ID of the OLT.

The SN request sent by the OLT to the ONU/ONT carries the logic registration ID of the OLT, and is intended to request an SN from the ONU/ONT and request authentication of the OLT. The request message sent by the OLT may be an existing PLOAM message, or a new message defined specially for transmitting this request, provided that the request message includes at least a message type filed (Message ID) and a logic registration ID (Register ID).

Preferably, in the embodiment of the present disclosure, a PLOAM message serves to transmit the request message, and the specific structure of the PLOAM message is shown in Table 3:

TABLE 3
Authentication Request PLOAM message for transmitting
logical registration ID of OLT
Authentication Request PLOAM message for transmitting
logical registration ID of OLT

| Byte | Content | Description |
|---|---|---|
| 1 | ONU/ONT-ID | Identifier of ONU/ONT |
| 2 | Message ID | Message ID |
| 3 | Register ID | Logic registration ID (byte 1) |
| 4-11 | . . . | . . . |
| 12 | Register ID | Logic registration ID (byte 10) |

In Table 3, the first byte “ONU/ONT-ID” is an identifier of the ONU/ONT that receives the authentication request; the second byte “Message ID” serves to indicate that the message is an authentication request message which carries the logic registration ID of the OLT; and bytes 3-12 serve to carry the logic registration ID of the OLT.

S202. After receiving the request message from the OLT, the ONU/ONT extracts the logic registration ID of the OLT from the request message, and matches it with the logic registration IDs of the legal OLTs stored in the ONU/ONT. If the logic registration IDs match, the authentication succeeds, and the procedure proceeds to S203; if the logic registration IDs do not match, the authentication fails, and the ONU/ONT aborts subsequent registration and authentication process by, for example, making no response to the authentication request sent by the OLT, or by reporting no SN for an SN request received from the OLT. The authentication is ended.

S203. The ONU/ONT returns a response message after determining that the OLT is legal. The response message includes an SN response and an authentication response, the SN response at least carries an SN of the ONU/ONT, and the authentication response at least carries the message ID and the logic registration ID (Register ID) of the ONU/ONT. The format of the response message may be an existing PLOAM message, or a new message defined specially for transmitting the response message, provided that the response message at least carries the SN, the message ID, and the logic registration ID (Register ID) of the ONU/ONT. Preferably, in the embodiment of the present disclosure, the response message is a PLOAM message, as shown in Table 4:

TABLE 4
PLOAM message for transmitting response message
sent by ONU/ONT
PLOAM message for transmitting response message
sent by ONU/ONT

| Byte | Content | Description |
|---|---|---|
| 1 | ONU/ONT-ID | Identifier of ONU/ONT |
| 2 | Message ID | Message ID |
| 3-12 | SN | Sequence number |
| 13-22 | Register ID | Logic registration ID |

In Table 4, the first byte “ONU/ONT-ID” serves to indicate the identifier of the ONU/ONT which sends an SN response; the second byte “Message ID” serves to indicate that the message is an SN response message which carries the logic registration ID of the ONU/ONT; bytes 3-12 serve to carry the SN of the ONU/ONT/ONT; and bytes 13-22 carry the logic registration ID of the ONU/ONT.

S204. After receiving the response message from the ONU/ONT, the OLT extracts the logic registration ID of the ONU/ONT, and matches it with the logic registration IDs of the legal ONU/ONTs stored in the OLT. The authentication succeeds if the logic registration ID reported by the ONU/ONT matches the logic registration IDs of the legal ONU/ONTs stored in the OLT, and the OLT records the SN of the legal ONU/ONT, allocates an ONU/ONT-ID for the legal ONU/ONT, and binds the SN of the ONU/ONT to the ONU/ONT-ID of the ONU/ONT. The authentication fails if the logic registration ID reported by the ONU/ONT does not match the logic registration IDs of the legal ONU/ONTs stored in the OLT, and the OLT determines the ONU/ONT as illegal and aborts the registration of the ONU/ONT.

S205. The OLT delivers the allocated ONU/ONT-ID to the ONU/ONT. By exchanging data with the ONU/ONT which is allocated the ONU/ONT-ID, the OLT registers the ONU/ONT. After the registration succeeds, the OLT configures service parameters for the successfully registered ONU/ONT by exchanging data with the successfully registered ONU/ONT.

As revealed in the method embodiments above, it is not necessary to configure the terminal SNs statically in the OLT and the operation administration system in the embodiments of the present disclosure, but a logic registration ID is applied in the detection and registration process; after the authentication succeeds, the terminal SN obtained from the legal terminal is recorded, and the terminal ID allocated for the legal terminal is recorded, and therefore, the OLT can discover and authenticate the terminal automatically. The terminal SN and the terminal ID obtained by the OLT in the automatic discovery and authentication process are transmitted to the operation administration system, and therefore, the operation administration system can obtain the terminal SN and the terminal ID dynamically, which avoids the process of configuring the terminal SN and the terminal ID by the operation administration system statically. When a terminal needs to be replaced for reasons such as faults, the new terminal can use the logic registration ID of the replaced terminal, which avoids the process of updating the statically configured SN by the operation administration system brought about by replacing the terminal. The operation administration system can manage the terminal SN and the terminal ID dynamically, and can maintain the OLT and the terminal conveniently by using the dynamically obtained terminal SN and terminal ID. In this way, the costs of maintaining the operation administration system, the OLT, and the terminal are reduced, and the terminal can be discovered and authenticated more flexibly. Moreover, the ONU/ONT discovers and authenticates the OLT, which prevents an illegal OLT (malicious OLT) from stealing user information and prevents leakage of user data.

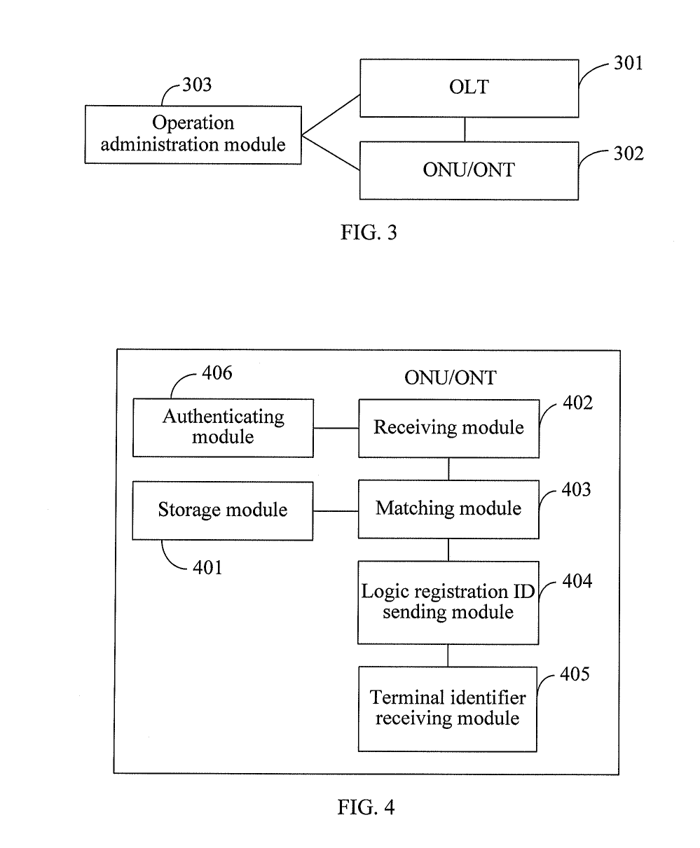

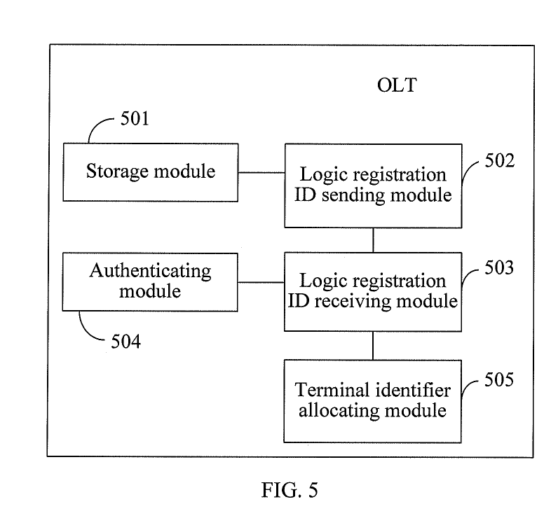

A third embodiment of the present disclosure provides a PON. The schematic structural diagram of the network system is as shown in FIG. 3. The system includes an ONU/ONT 302 that stores the logic registration IDs of the legal OLTs, and an OLT 301 that stores the logic registration IDs of the legal ONU/ONTs.

The ONU/ONT 302 is configured to receive a first negotiation message which is sent by the OLT 301 and carries the logic registration ID of the OLT 301, and authenticate the OLT according to the logic registration ID of the OLT 301.

The OLT 301 is configured to receive a second negotiation message which is sent by the ONU/ONT 302 and carries the logic registration ID of the ONU/ONT 302, and authenticate the ONU/ONT 302 according to the logic registration ID of the ONU/ONT 302.

After the authentication on both the ONU/ONT 302 and the authentication on the OLT 301 succeed, the OLT 301 sends a terminal identifier which is allocated for the ONU/ONT 302 to the ONU/ONT 302.

Further, the OLT 301 is further configured to authenticate the ONU/ONT 302 according to the logic registration ID of the ONU/ONT 302 and the information stored on the OLT 301; or

The OLT 301 authenticates the ONU/ONT 302 according to the logic registration ID of the ONU/ONT 302 and remote server interaction information.

The information stored in the OLT 301 may be logic registration IDs or any other information, so long as the information is enough for authenticating the ONU/ONT 302 and ensures security of the authentication. When the ONU/ONT 302 is authenticated according to the remote server interaction information, the specific type of the interaction message may be the logic registration IDs or any other information, so long as the information is enough for authenticating the ONU/ONT 302 and ensures security of the authentication.

The system may further include an operation administration apparatus 303, which is configured to generate the logic registration IDs of the legal OLTs and the logic registration IDs of the legal ONU/ONTs, send the logic registration IDs of the legal OLTs to the ONU/ONT 302 and send the logic registration IDs of the legal ONU/ONTs to the OLT 301. The functions of the operation administration apparatus 303 are the same as the functions of the operation administration system described above, and are not described in detail here. Further, the type and the format of the logic registration ID of the OLT and the ONU/ONT are the same as those described above, and are not described in detail here.

A fourth embodiment of the present disclosure provides an ONU/ONT which is located on a user side of a PON. As shown in FIG. 4, the ONU/ONT includes:

a storage module 401, configured to store logic registration IDs of legal OLTs;

a logic registration ID receiving module 402, configured to receive a first negotiation message sent by the OLT, where the first negotiation message carries the logic registration ID of the OLT;

a matching module 403, configured to match the logic registration ID of the OLT received by the receiving module 402 with the logic registration IDs of the OLTs authorized for access stored in the storage module 401;

a logic registration ID sending module 404, configured to send a second negotiation message which carries a logic registration ID of the ONU/ONT to the OLT, so that the OLT authenticates the ONU/ONT according to the logic registration ID of the ONU/ONT; and

a terminal identifier receiving module 405, configured to receive a terminal identifier which is sent by the OLT and allocated for the ONU/ONT, where the terminal identifier is sent after the authentication on both the ONU/ONT and the authentication on the OLT succeed.

The ONU/ONT may further include an authenticating module 406, which is configured to send an authentication request to the OLT to request the logic registration ID of the OLT. The type and the format of the logic registration ID are the same as those described above, and are not described in detail here.

An embodiment of the present disclosure further provides an OLT which is located in the central office of the PON. The OLT includes:

a storage module 501, configured to store the logic registration ID of the OLT;

a logic registration ID sending module 502, configured to send a first negotiation message which carries the logic registration ID of the OLT to the ONU/ONT, so that the ONU/ONT authenticates the OLT according to the logic registration ID of the OLT;

a logic registration ID receiving module 503, configured to receive a second negotiation message which carries a logic registration ID of the ONU/ONT and is returned by the ONU/ONT after the ONU/ONT succeeds in authenticating the OLT according to the logic registration ID of the OLT;

an authenticating module 504, configured to authenticate the ONU/ONT according to the logic registration ID of the ONU/ONT carried in the second negotiation message, and notify a terminal identifier allocating module to allocate a terminal identifier for the ONU/ONT after determining that the authentication on the OLT succeeds; and

the terminal identifier allocating module 505, configured to allocate the terminal identifier for the ONU/ONT as notified by the authenticating module, and send the allocated terminal identifier to the ONU/ONT.

Further, the storage module 501 is configured to store the logic registration IDs of the legal ONU/ONTs, and the authenticating module matches the logic registration ID of the ONU/ONT in the second negotiation message with the logic registration IDs stored in the storage module, and the authentication on the OLT succeeds if the logic registration IDs matches. The type of the logic registration ID is the same as that described in the method embodiment above, and is not described in detail here.

Persons of ordinary skill in the art should understand that all or part of the steps of the method under the present disclosure may be implemented by relevant hardware under the instruction of computer programs. The program may be stored in computer readable storage media. When the program runs, the program executes the method specified in any embodiment of the present disclosure above. The storage media may be a magnetic disk, an optical disk, Read-Only Memory (ROM), or Random Access Memory (RAM), etc.

The method, apparatus and system provided in the embodiments of the present disclosure are described in detail above. Specific examples are applied herein to set forth the principle and implementation mode of the present disclosure, but the disclosure of the embodiments is merely for facilitating the understanding of the method and core ideas of the present disclosure. Meanwhile, modifications of both specific implementation mode and application scope will occur to persons of ordinary skill in the art pursuit to the idea of the present disclosure. In summary, the content of the specification should not be construed to limit the present disclosure.

What is claimed is:

1. A method for authentication in a Passive Optical Network (PON), comprising:
receiving, by an Optical Network Unit/Optical Network Terminal (ONU/ONT), a first negotiation message sent by an Optical Line Terminal (OLT), wherein the first negotiation message carries a logic registration ID of the OLT,
authenticating, by the ONU/ONT, the OLT according to the logic registration ID of the OLT;
sending, by the ONU/ONT, a second negotiation message to the OLT, wherein the second negotiation message carries a logic registration ID of the ONU/ONT, the logic registration ID of the ONU/ONT is used to enable the OLT to authenticates the ONU/ONT; and
receiving, by the ONU/ONT, a terminal identifier sent by the OLT, wherein the terminal identifier is allocated for the ONU/ONT after both the authentication on the ONU/ONT and the authentication on the OLT succeed.

2. The method according to claim 1, further comprising:
authenticating, by the OLT, the ONU/ONT according to the logic registration ID of the ONU/ONT and one of information stored on the OLT and remote server interaction information.

3. The method according to claim 2, further comprising:
receiving, by the ONU/ONT, a request message sent by the OLT for reporting a Serial Number (SN) before the ONU/ONT receives the first negotiation message sent by the OLT, and
sending, by the ONU/ONT, a first authentication request to the OLT upon receiving the request message for reporting the SN,
wherein the first authentication request is configured to request authentication on the OLT, and the first negotiation message received by the ONU/ONT from the OLT is an authentication response that carries the logic registration ID of the OLT.

4. The method according to claim 2, further comprising:
reporting, by the ONU/ONT, the SN of the ONU/ONT to the OLT after the ONU/ONT authenticates the OLT successfully.

5. The method according to claim 4, wherein the SN of the ONU/ONT is carried in the second negotiation message.

6. The method according to claim 1, wherein the logic registration ID of the OLT comprises: a device type of the OLT, version information of the OLT, a Media Access Control (MAC) address of the OLT, PON port information of the OLT, or function information of the OLT, or any combination thereof.

7. The method according to claim 1, wherein the authenticating, by the ONU/ONT, the OLT according to the logic registration ID of the OLT comprises:
extracting, by the ONU/ONT, the logic registration ID of the OLT from the first negotiation message; and
matching, by the ONU/ONT, the logic registration ID o f the OLT with pre-stored logic registration IDs of OLTs authorized for access; and
determining, by the ONU/ONT, that the authentication succeeds upon a condition that the logic registration ID of the OLT matches one of the pre-stored logic registration IDs.

8. A Passive Optical Network (PON), comprising an optical line terminal (OLT) and an Optical Network Unit/Optical Network Terminal (ONU/ONT):
wherein the ONU/ONT is configured to receive a first negotiation message sent by the OLT and carrying a logic registration ID of the OLT, and authenticate the OLT according to the logic registration ID of the OLT; and
the OLT is configured to receive a second negotiation message sent by the ONU/ONT and carrying a logic registration ID of the ONU/ONT, authenticate the ONU/ONT according to the logic registration ID of the ONU/ONT, and send a terminal identifier to the ONU/ONT, wherein the terminal identifier is allocated for the ONU/ONT after both the authentication on the ONU/ONT and the authentication on the OLT succeed.

9. The PON according to claim 8, wherein:
the OLT authenticates the ONU/ONT according to the logic registration ID of the ONU/ONT and one of information stored on the OLT and remote server interaction information.

10. The PON according to claim 8, wherein:
the first negotiation message is a request message that instructs the ONU/ONT to report a Serial Number (SN); and the second negotiation message carries the SN of the ONU/ONT.

11. The PON according to claim 8, wherein:
the logic registration ID of the OLT comprises: a device type of the OLT, version information of the OLT, a Media Access Control (MAC) address of the OLT, PON port information of the OLT, or function information of the OLT, or any combination thereof; and
the logic registration ID of the ONU/ONT comprises: a device type of the ONU/ONT, version information of the ONU/ONT, a MAC address of the ONU/ONT, or function information of the ONU/ONT, or any combination thereof.

12. An Optical Network Unit/Optical Network Terminal (ONU/ONT), comprising:
a logic registration ID receiving module, configured to receive a first negotiation message sent by an OLT and carrying a logic registration ID of the OLT;
a matching module, configured to match the logic registration ID of the OLT received by the receiving module with logic registration IDs of OLTs authorized for access;
a logic registration ID sending module, configured to send a second negotiation message which carries a logic registration ID of the ONU/ONT to the OLT, wherein the logic registration ID of the ONU/ONT is used to enable the OLT to authenticates the ONU/ONT; and
a terminal identifier receiving module, configured to receive a terminal identifier allocated for the ONU/ONT, wherein the terminal identifier is sent by the OLT after both the authentication on the ONU/ONT and the authentication on the OLT succeed.

13. The ONU/ONT according to claim 12, wherein the ONU/ONT further comprises an authenticating module, configured to send an authentication request to the OLT to request the logic registration ID of the OLT.

14. The ONU/ONT according to claim 12, wherein:
the logic registration ID of the OLT comprises: a device type of the OLT, version information of the OLT, a Media Access Control (MAC) address of the OLT, PON port information of the OLT, or function information of the OLT, or any combination thereof.

15. The ONU/ONT according to claim 12, further comprising:
a storage module, configured to store logic the registration IDs of Optical Line Terminals (OLTs) authorized for access and the logic registration ID of the ONU/ONT.

16. The ONU/ONT according to claim 12, wherein the first negotiation message is a request message that instructs the ONU/ONT to report a Serial Number (SN), and the second negotiation message carries the SN of the ONU/ONT.

17. An Optical Line Terminal (OLT), comprising:
a logic registration ID sending module, configured to send a first negotiation message carrying a logic registration ID of the OLT to an Optical Network Unit/Optical Network Terminal (ONU/ONT), the logic registration ID of the OLT is used to enable the ONU/ONT authenticates the OLT;
a logic registration ID receiving module, configured to receive a second negotiation message carrying a logic registration ID of the ONU/ONT, wherein the second negotiation message is returned by the ONU/ONT after the ONU/ONT succeeds in authenticating the OLT according to the logic registration ID of the OLT;
an authenticating module, configured to: authenticate the ONU/ONT according to the logic registration ID of the ONU/ONT in the second negotiation message; and
a terminal identifier allocating module, configured to allocate a terminal identifier for the ONU/ONT after the authenticating module determining that the authentication on the OLT succeeds, and send the allocated terminal identifier to the ONU/ONT.

18. The OLT according to claim 17, further comprising:
a storage module configured to store logic registration ID of legal ONU/ONTs, and the authenticating module matches the logic registration ID of the ONU/ONT in the second negotiation message with the logic registration IDs of legal ONU/ONTs stored in the storage module, and determine that the authentication on the OLT succeeds if the logic registration IDs match.

19. The OLT according to claim 17, wherein:
the logic registration ID of the OLT comprises: a device type of the OLT, version information of the OLT, a Media Access Control (MAC) address of the OLT, PON port information of the OLT, or function information of the OLT, or any combination thereof.

20. The OLT according to claim 17, wherein the first negotiation message is a request message that instructs the ONU/ONT to report a Serial Number (SN), and the second negotiation message carries the SN of the ONU/ONT.
